(19) United States
(12) Patent Application Publication
(10) Pub. No.: US 2002/0025581 A1
(43) Pub. Date: Feb. 28, 2002

(54) Vial handling system with improved sample extraction

(76) Inventors: Harry W. Schmidt, Fairfield, OH (US); David M. Neal, Hamilton, OH (US)

Correspondence Address: Christopher R. Christenson, WESTMAN,CHAMPLIN & KELLY, P.A., Suite 1600 - International Centre, 900 Second Avenue South, Minneapolis, MN, 55402-3319, US

(21) Appl. No.: 09/803,412

(22) Filed: Mar. 9, 2001

Related U.S. Application Data
(60) Provisional application No. 60/188,665, filed on Mar. 11, 2000.
(60) Provisional application No. 60/188,269, filed on Mar. 10, 2000.

(51) Int. Cl. G01N 35/10

(52) U.S. Cl. 436/180; 422/100; 422/63; 436/43

(57) ABSTRACT

A vial autosampler includes a sampling module with a sampling needle. The module is adapted to bring the sampling needle and a vial together such that the sampling needle pierces a septum on the vial. The autosampler also includes a sealing boot disposed about the sampling needle. The sealing boot engages the vial septum when the vial is fully engaged with the sample needle.

### CROSS REFERENCE TO RELATED APPLICATIONS

This application claims the priority of earlier filed co-pending provisional patent application Nos. 60/188,665, filed Mar. 11, 2000 and entitled IMPROVED VIAL HANDLING SYSTEM; and 60/188,269 filed Mar. 10, 2000 and entitled WATER AND SOIL AUTOSAMPLER.

### BACKGROUND OF THE INVENTION

The present invention relates to vial autosamplers of the type used for laboratory automation. More specifically, the present invention relates to sample extraction within the vial autosampler.

Vial autosamplers are used to automate laboratory analyses associated with gas chromatography, carbon measurement (total carbon and total organic carbon) as well as other types of analyses. Typically, a vial autosampler has a storage area adapted to hold a number of vials to be analyzed. A robotic system generally grasps one of the vials and transports it from the storage area to an analytical site. Once transported to the analytical site, the vial contents are sampled and the appropriate analysis is performed.

Autosamplers typically use separate sampling modules for extracting liquid and gas samples. One example of such an autosampler is described in U.S. Pat. No. 5,948,360 to Rao et al. and assigned to Tekmar Company of Cincinnati, Oh. Liquid sampling typically involves extracting a known quantity of liquid from the vial that is presented to the sampling module of the autosampler, adding a standard to the sample, and transferring the sample to an analytical device. Under certain situations, the specimen must be diluted by a technician by injecting the specimen with a specified volume of methanol or a water-based solution prior to sampling. The extracted sample or methanol extract is then diluted with water prior to analysis by the analytical device.

Gas headspace extraction generally involves injecting the specimen with a solvent, such as water, agitating the specimen, and purging the specimen with a gas. Some autosamplers are adapted to perform static headspace extraction while others are adapted to perform dynamic headspace extraction. In static headspace extraction, the specimen is purged from above the specimen and the headspace is removed and transferred to the analytical device. In dynamic headspace extraction, the specimen is purged from underneath the specimen and the head space is removed and then transferred to the analytical instrument. Autosamplers that are capable of performing the above sample extraction include the Precept II and the 7000 HT autosamplers sold by Tekmar-Dohrmann, of Cincinnati, Oh.

Since some sample extraction techniques, such as gas headspace extraction, involve bubbling a purge gas through the specimen, it is important to seal the vial to the needle during sample extraction. Ideally, an hermetic seal would be provided between the resilient vial septum and the needle sidewall. However, irregularities in both septum resiliency and needle sidewall surfaces can sometimes allow analytes to leak between the needle sidewall and the septum. Such leakage releases analytes and purge gas into the laboratory itself, and can reduce the sensitivity of the analysis. Thus, it is important for a laboratory device such as an autosampler to reduce or even eliminate analyte leakage during extraction.

### SUMMARY OF THE INVENTION

A vial autosampler includes a sampling module with a sampling needle. The module is adapted to bring the sampling needle and a vial together such that the sampling needle pierces a septum on the vial. The autosampler also includes a sealing boot disposed about the sampling needle. The sealing boot engages the vial septum when the vial is fully engaged with the sample needle.

### BRIEF DESCRIPTION OF THE DRAWINGS

FIG. 1 is a perspective view of an illustrative automatic vial handling system with which embodiments of the present invention are useful.

FIG. 2 is an elevation view of a portion of a vial autosampler illustrating an embodiment of the present invention.

FIG. 3 is a side elevation view of a vial in an extraction position illustrating a sealing boot in accordance with an embodiment of the present invention.

### DETAILED DESCRIPTION OF THE PREFERRED EMBODIMENTS

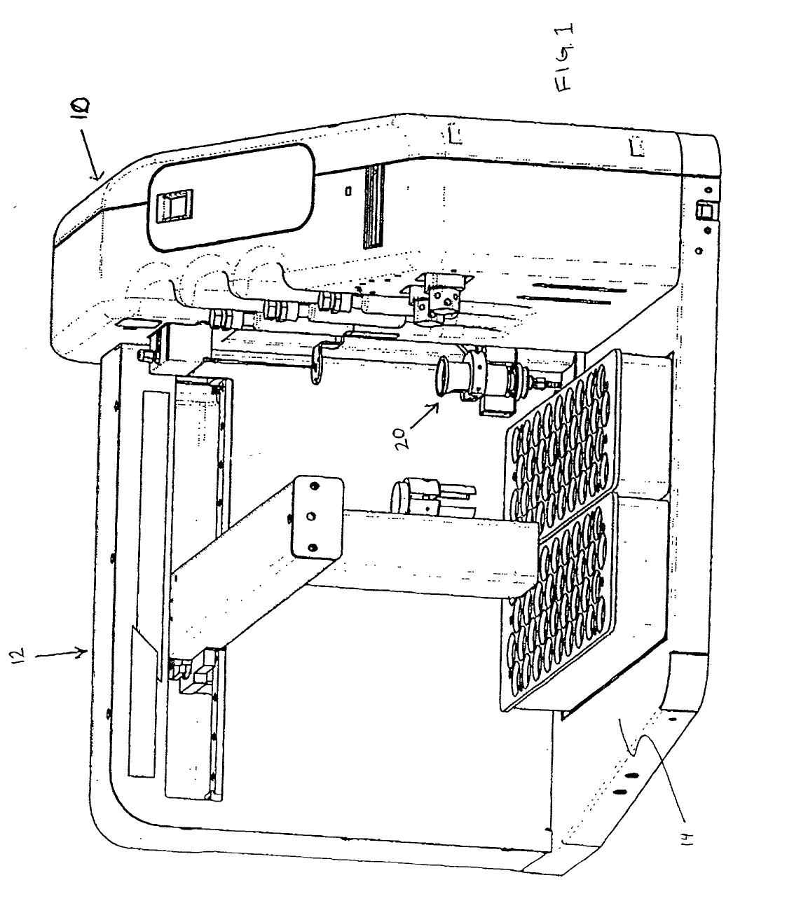

FIG. 1 shows a perspective view of a vial autosampler device 10 in accordance with the invention. Device 10 includes a base unit 12 that includes a vial storage platform area 14, a sampling station 20, and a fluid handling system comprising valves, glasswork, an other fluid handling components. Sampling station 20 receives a vial containing a specimen and extracts a fluid from the vial for further analysis. Finally, device 10 includes a central programmable control circuit that accepts user inputs and controls the operation of device 10.

In operation, a vial is selected from vial storage are 14 and transported to an analytical site. The vial is generally positioned within a vial cup in the sampling module, which lifts the vial such that a resilient septum, generally on top of the vial, is pierced by a stationary needle. Once the needle has pierced the septum, a sample is obtained. As mentioned above, one way the sample can be obtained is by injecting a solvent such as water, and bubbling a purge gas through the specimen. As the purge gas passes through the specimen, analytes become entrained by the gas. The purge gas with entrained analytes is recovered and analyzed in accordance with any suitable technique.

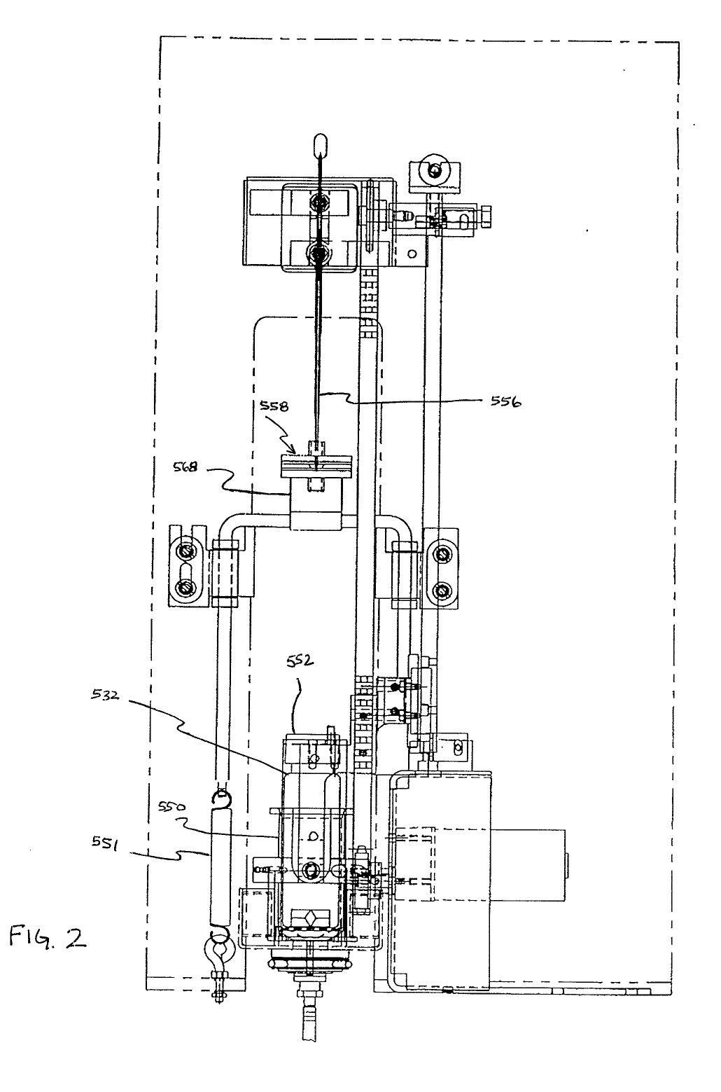

FIG. 2 is an elevation view of a portion of a vial autosampler illustrating an embodiment of the present invention. FIG. 2 illustrates vial 532 held within vial cup 550. Vial cup 550 is coupled to an elevator mechanism that is adapted to raise vial cup 550 and vial 532. In operation, vial cup 550 lifts vial 532 to contact needle 556 for sample extraction. As vial 532 nears needle 556, vial 532 contacts sealing boot 558 and seals with the end-cap 552 of vial 532. End-cap 552 includes a septum that is pierceable by needle 556. As vial 532 is elevated further, needle 556 pierces septum 554 thus allowing needle 556 to obtain a sample from within vial 532. As needle 556 pierces septum 554, vial tab 568 raises against the urging of spring 551. As illustrated in FIG. 2, when a vial is not engaged with needle 556, sealing boot 558 is disposed about the bottom of needle 556 thereby protecting both needle 556 and users from accidental contact.

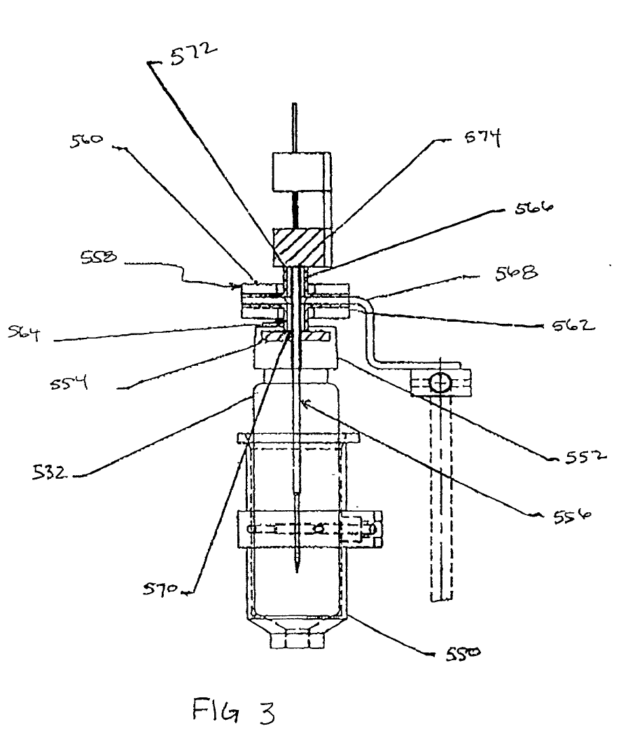

FIG. 3 is an enlarged side elevation view illustrating sealing boot 558 in accordance with an embodiment of the present invention. Although embodiments of the invention are described with respect to a vial being moved onto a stationary needle, such embodiments are equally practicable with autosamplers that move a needle into a stationary vial.

Vial sealing boot 558, in accordance with an embodiment of the present invention, helps reduce analyte leakage during sampling. Vial sealing boot 558 is illustrated as part of an ejector mechanism, but can be provided separately. An ejector mechanism assists in the removal of needle 556 from vial 532 by providing a downward force upon vial 532 as vial 532 is lowered thereby countering the tendency of vial 532 to stick to needle 556 and lift away from cup 550. Vial sealing boot 558 preferably includes upper plate 560, lower plate 562, lower gasket 564, and upper gasket 566. As can be seen, upper and lower gaskets 560, 564 are disposed about needle 556 to the interface of needle 556 and septum 554. Preferably, upper and lower plates 560 and 562 are mounted relative to vial eject tab 568.

When vial cap 550 moves vial 532 into the fully raised position, sealing surface 570 on septum 554 bears against lower gasket 564 providing a seal therewith. Additionally, upper seal 566 bears against, and seals with, upper sealing surface 572 on needle block 574. Thus, analytes that leak from the interface between the outer diameter of needle 556 and septum 554, will be trapped by lower gasket 564, upper gasket 566, and sealing surface 572. In this manner, analyte loss is reduced thereby increasing the efficiency of analysis.

Lower seal 564 and upper seal 566 are preferably constructed from a material that is chemically inert and thus is generally unaffected by contact with various analytes. One such example of a chemically inert material suitable for an embodiment of the present invention is silicone rubber. In order to select a sealing material that is suitably deformable, it is preferred that the hardness of the sealing material be selected to be between a range of about 30 to about 90 durometer D. Preferably, lower seal 564 and upper seal 566 are constructed from silicone rubber having a durometer of 40.

Although the present invention has been described with reference to preferred embodiments, workers skilled in the art will recognize that changes may be made in form and detail without departing from the spirit and scope of the invention.

What is claimed is:

1. A vial autosampler comprising:
a sampling module including a sampling needle and being adapted to bring the sampling needle and a vial together such that the sampling needle pierces a septum on the vial;
a sealing boot disposed about the sampling needle; and
wherein the sealing boot engages the vial septum when the vial is fully engaged with the sample needle.

2. The autosampler of claim 1, and further comprising an ejector tab coupled to the sealing boot, the ejector tab providing urging the vial from the sampling needle upon completion of sample acquisition.

3. The autosampler of claim 2, wherein the sealing boot is constructed from a chemically inert material.

4. The autosampler of claim 3, wherein the chemically inert material is silicone rubber.

5. The autosampler of claim 4, wherein the silicone rubber has a hardness selected to be between a range of about 30 to about 90 durometer D.

6. The autosampler of claim 5, wherein the silicone rubber has a hardness of about 40 durometer D.

7. The autosampler of claim 2, wherein the sealing boot further comprises an upper plate disposed on a first side of the ejector tab, and a lower plate disposed on a second side of the ejector tab, and wherein the sealing boot further comprises a first gasket sealing between the upper plate and the ejector tab, and a second gasket sealing between the lower plate and the ejector tab.

8. The autosampler of claim 7, wherein the second gasket engages the septum and the first gasket engages a needle block.

9 The autosampler of claim 1, wherein the sealing boot is adapted to limit analyte leakage between the sampling needle and the septum.

10. The autosampler of claim 1, wherein the sealing boot is disposed proximate a tip of the sampling needle when a vial is not engaged with the sampling needle.

11. The autosampler of claim 1, and further comprising a needle block, and wherein the sealing boot contacts the needle block when the sampling needle and vial are brought together such that a septum of the vial is pierced by the sampling needle, and wherein the sealing boot reduces analyte leakage.

12. A vial autosampler comprising:
means for storing vials;
means for selecting and transporting a selected one of the vials;
means for obtaining a sample from the selected vial;
means for sealing to reduce analyte loss during sample acquisition from the selected vial.

13. A method of obtaining a sample from a vial in an autosampler, the method comprising:
bringing a sampling needle and vial together such that a septum of the vial is pierced by the sampling needle; and
engaging a sealing boot with the vial septum to reduce analyte leakage.

14. The method of claim 13, wherein the step of engaging the sealing boot further comprises engaging the sealing boot with a needle block to form a sealed volume between the sealing boot, the vial septum, and the needle block.
